(19) United States
(12) Patent Application Publication
(10) Pub. No.: US 2004/0015840 A1
(43) Pub. Date: Jan. 22, 2004

(54) Mechanism for converting between JAVA classes and XML

(75) Inventor: William J. Walker, Red Bank, NJ (US)

Correspondence Address: BIRCH STEWART KOLASCH & BIRCH, PO BOX 747, FALLS CHURCH, VA, 22040-0747, US

(73) Assignee: Avaya, Inc.

(21) Appl. No.: 09/837,929

(22) Filed: Apr. 19, 2001

(51) Int. Cl. G06F 9/44

(52) U.S. Cl. 717/108; 717/114; 717/166

(57) ABSTRACT

A method, applications programming interfaces (API), and mechanism for converting between JAVA classes and XML. In a file containing JAVA data representations, each JAVA class having elements to be converted to an XML representation is annotated in a manner enabling appropriate conversion processing by an API generating therefrom an XML file. The annotation enables instances of Java class objects to be converted to an XML representation and XML representations to be converted to Java class objects.

### TECHNICAL FIELD

The invention relates to a computer program, method and system for converting between JAVA classes and eXtensible Markup Language (XML).

### BACKGROUND OF THE INVENTION

JAVA and XML (eXtensible Markup Language) technologies provide developers with the tools to write portable code and operate on portable data. JAVA is a registered trademark of Sun Microsystems, Inc. of Palo Alto, Calif. Support for XML in the JAVA platform is increasing with the availability of standard applications programming interfaces (APIs) and parsers, such as Simple API for XML (SAX) and the document object model (DOM). SAX is a public domain standard applications programming interface including an event driven interface that provides a mechanism for “call back” notifications to an applications code as the underlying parser recognizes XML syntactic constructions in a document. DOM is a set of interfaces for a programmatic representation of a parsed XML (or HTML) document. While these APIs provide standard mechanisms for reading XML documents, they work at a relatively low level. Using DOM, for example, developers must have a detailed understanding of how to use the API to navigate nodes, elements, attributes, and to extract textual content and then convert the text to useful program data types. This process is tedious, error prone, and requires the developer to work with JAVA classes outside the application domain.

A technical proposal put forth by Sun Microsystems is described in a document entitled “An XML Data-Binding Facility for the JAVA Platform,” by Mark Reinhold of the Core JAVA Platform Group, published Jul. 30, 1999. In this paper, a schema compiler is proposed that generates JAVA classes from an XML schema. Unfortunately, the use of a schema compiler is problematic and limiting to a developer in terms of control and flexibility of the mapping of JAVA classes to XML.

### SUMMARY OF THE INVENTION

The invention comprises a method, applications programming interfaces (API), and mechanism for converting between JAVA classes and XML. In a file containing JAVA data representations, each JAVA class having elements to be converted to an XML representation is annotated in a manner enabling appropriate conversion processing by an API generating therefrom an XML file. The annotation enables instances of Java class objects to be converted to an XML representation, and XML representations to be converted to JAVA class objects.

The invention utilizes an annotation to each JAVA class to be converted between a JAVA class structure and XML. Moreover, given a JAVA class having one or more sub-elements, each of the one or more sub-elements to be converted to XML is also annotated. Thus, given a plurality of JAVA classes, where each JAVA class may have associated with it a plurality of sub-elements, those JAVA classes to be converted to XML representations, and their respective sub-elements to be converted to XML representations, are annotated to include an interface according to the invention.

### BRIEF DESCRIPTION OF THE DRAWINGS

The teachings of the present invention can be readily understood by considering the following detailed description in conjunction with the accompanying drawings, in which:

FIG. 1 depicts a simplified block diagram of a computing system adapted according to the present invention;

FIG. 2 depicts a flow diagram of a method for processing a JAVA file; and

FIG. 3 depicts a flow diagram of an annotation method according to the invention and suitable for use in the method of FIG. 2;

FIG. 4 depicts a flow diagram of a method for converting a JAVA class into an XML representation.

FIG. 5 depicts a flow diagram of a method for converting an XML document to a JAVA class representation; and

FIG. 6 depicts a high level graphical representation of processing useful in understanding the present invention.

To facilitate understanding, identical reference numerals have been used, where possible, to designate identical elements that are common to the figures.

### DETAILED DESCRIPTION OF THE INVENTION

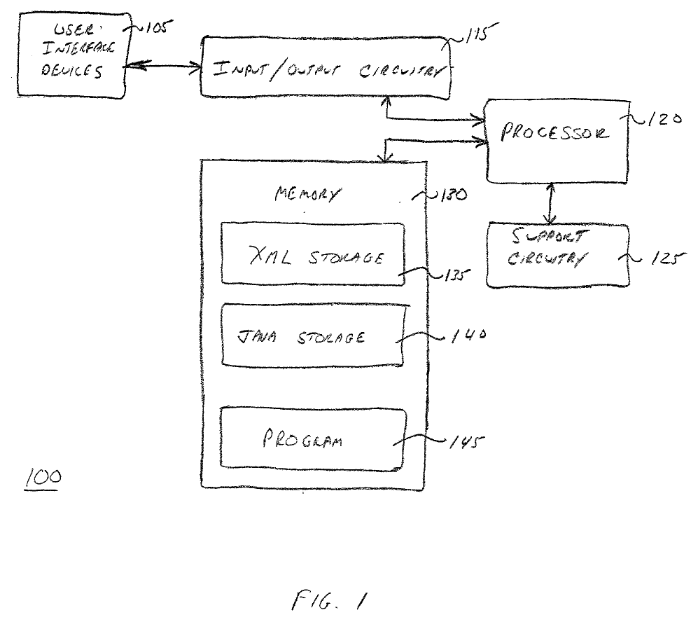

FIG. 1 depicts a simplified block diagram of a computing system adapted according to the present invention. Specifically, FIG. 1 depicts a general purpose computer comprising a processor 120, input/output (I/O) circuitry 115, support circuitry 125, memory 130 and user interface devices 105. The user interface devices 105 comprise a display screen, a keyboard, a mouse, a track ball and/or other user interface devices commonly known to those skilled in the art. The user interface devices 105 are coupled to the processor 120 via the I/O circuitry 115.

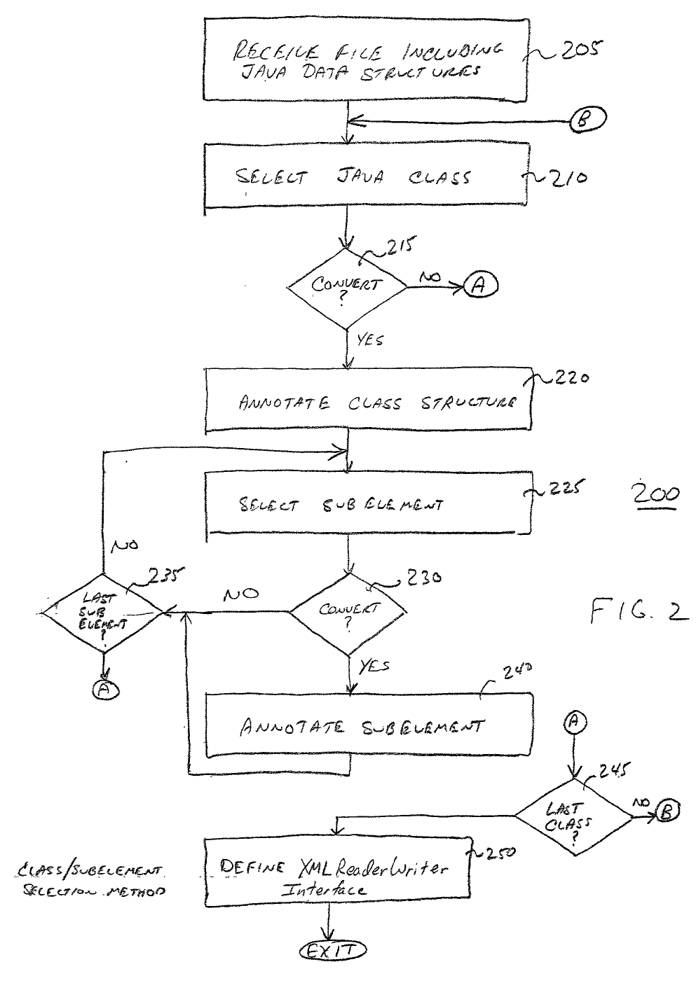

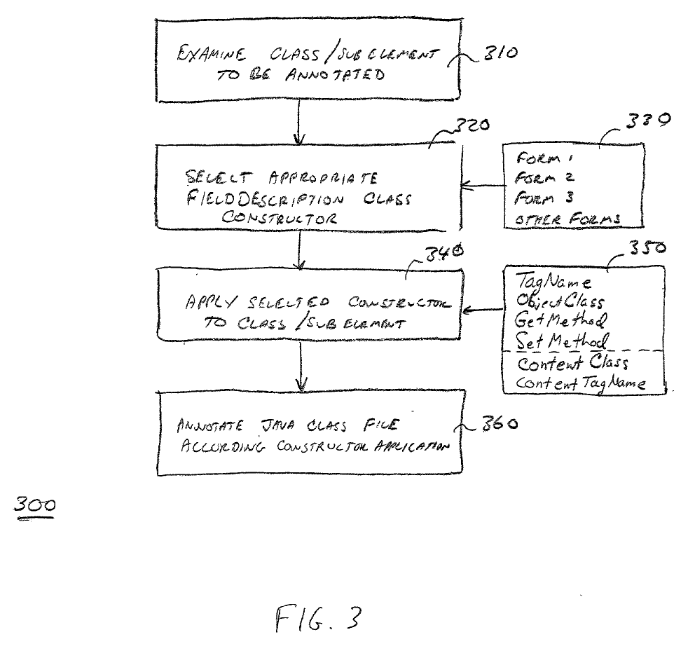

The memory 130 may be a solid state memory, a disk drive, an optical memory, a removable memory device, or a combination of any of these memory devices or similar memory devices. The support circuitry 125 comprises such well known support components as cache memory, power supplies, clock circuits and the like. The combination of all these components and elements forms a general purpose computer that, when executing a particular software package or routine, becomes a special purpose computer. In this case, the prosecutor 120 when executing a program 145, becomes a special purpose computer adapted to the relevant program or function. It is noted that the program 145 includes functionality capable of converting between JAVA classes and XML. The memory 130 is depicted as including an XML storage region 135 and a JAVA storage region 140. It is noted that XML and/or JAVA data may instead be stored in a temporary storage region of memory while the program 145 performs various processing functions in accordance with the teachings of the present invention, such as described in more detail below with respect to FIGS. 2-3. As such, it is not necessary to the practice of this invention to include specific storage regions. Moreover, it is noted that the teachings of the present invention are adaptable to other programming languages and structures (not shown).

It will be appreciated by those skilled in the art that one embodiment is implemented as a program product for use with a computer system such as, for example, the system 100 shown in FIG. 1. The program or programs of the program product define functions of the preferred embodiment and can be contained on a variety of signal bearing media, which include, but are not limited to, information permanently stored on non-writable storage media (e.g., read only memory devices within a computer such as a CD ROM disk readable by a CD ROM drive); alterable information stored on writable storage media such as floppy disks within a diskette drive or hard disk drive; or information conveyed to a computer by a communications medium, such as a semiconductor memory or through a computer or telephone network including wireless communications. Such signal-bearing media, when carrying the computer-readable instructions that direct the functions of the present invention, represent embodiments of the present invention.

It is noted that the user interface devices 105 may also include network interface devices capable of communicating with external networks, such as the Internet or a local area network (LAN).

The invention allows developers, for example, to convert easily between JAVA and XML representations of data while working exclusively with classes from the application domain. The invention enables developers to easily add XML support for complex hierarchies of any user-defined class, JAVA primitives (int, float, boolean, etc.) and wrapper classes (Integer, Boolean, Float, etc.) as well as collections and arrays of such objects.

An API in accordance with the invention advantageously avoids the use of a schema compiler to generate new JAVA classes. The invention also new or existing classes to be easily annotated to work with the API. A developer utilizing the invention has full control and flexibility over how the classes get mapped to XML. Also, the totally different class implementations can work with the same XML representation in different ways.

The invention provides a mechanism that is applicable to any application written in JAVA and using XML as an external data exchange format. The mechanism will work with any XML parser that implements the standard W3C Document Object model. XML representations are easily converted directly into the JAVA objects and data types used by developers within their application.

An embodiment of the invention will be described within the context of a particular application; namely, a “book store” application in which a data set related to the operation of a book store is represented by an appropriate group of JAVA and/or XML data descriptors. First, a data set associated with the book store will be described within the context of an XML document and as a corresponding group of JAVA classes. Next, the operation of the invention will be shown within the context of converting the book store data set between JAVA and XML descriptors.

### Book Store Data Set

Data is described in XML in a hierarchical manner by tagging elements. An XML document contains one single element (the document element) that may contain any number of other elements. For example, an XML representation of a book store may be written as:

<bookStore>

<name>The Programmer's Book Store</name>
<address>

<street>1 Industrial Way</street>
<city>Middletown</city>
<state>NJ</state>
<zip>07701</zip>

</address>
<books>

<book reviewed=”no ”>

<title>Xml and JAVA</title>
<author>Hiroshi Maruyama</author>
<cost>$49.00</cost>

</book>
<book reviewed=”yes”>

<title>JAVA in a Nutshell</title>
<author>Flannigan</author>
<cost>$39.00</cost>
<review>

<reviewedBy>Joe</reviewedBy>
<rating>3.5</rating>

</review>
<review>

<reviewedBy>Bob</reviewedBy>
<rating>9.5</rating>

</review>

</book>

</books>

</bookStore>

The above XML document contains a single element bookStore, which has sub-elements for name, address, and books. The books element contains a collection of book elements. Elements may contain one or more “attributes” such as the reviewed attribute of book, used in this example to indicate whether the respective book has been reviewed or not. Books that have been reviewed contain one or more review elements.

The above XML representation of a book store can be modeled by the following set of JAVA classes:

class BookStore {

String name;
Address address;
Vector books;
// ... public methods

}
class Address {

String street;
String city;
String state;
String zip;
// ... public methods

}

class Book {
String author;
String title;
float cost;
// public methods

}
class ReviewedBook extends Book {

Vector reviews;
void addReview(Review review);
Vector getReviews() { return reviews; }

}

### Converting Between JAVA and XML Data

An applications programming interface (API) according to an embodiment of the invention enables a developer to construct the “book store” data using JAVA only, and then convert the “book store” JAVA classes to an XML representation. The invention also enables the reconstruction of the “bookstore” JAVA classes from the XML representation. It is important to note that the invention allows for the construction of corresponding JAVA classes from an XML file that has not been generated using the API. That is, an XML file is processed to derive appropriate JAVA class information structures such that a JAVA file (optionally including annotations according to the invention) is produced.

An API according to the invention may implement the above described functionality using, for example, mechanisms of the following form:

BookStore bookStore=new BookStore(“The Programmer's Book Store”);

BookStore.setAddress(new Address(“1 Maple St.”, “Middletown”, “N.Y.”));

Book book=new Book(“JAVA in a Nutshell”, “Flannigan”);

Book.setCost(49.0f);

BookStore.add(book);

SaveToXml(bookStore, “bookStore.xml”); H a hypothetical method

//later, read the contents back to JAVA

BookStore bookStore=ReadFromXml(“bookStore.xml”); 1 a hypothetical method Collection books=bookStore.getBooks( );

The above mechanisms implementing the API comprise two methods; mainly, SaveToXml and ReadFromXml. The SaveToXml method converts a JAVA class, illustratively the BookStore JAVA class into a corresponding XML representation. The ReadFromXML method retrieves the JAVA class contained within an XML representation. The functions enabling such a mechanism will now be described in more detail.

The XmlReaderWriterInterface

In order to convert user-defined JAVA objects or types to XML, such as BookStore, Address, Book, and Review in the above example, each JAVA object or type must include instructions about how to do the conversion. Specifically, the following information is preferably provided to the API: (1) an indication of the fields within a JAVA object to be saved to an XML document. For example, it may be desirable to provide a JAVA class containing various fields that are only used (or useful within) a JAVA environment and, therefore, are not appropriate or useful within an XML document; (2) for each field to be converted, a TagName should be provided for use in generating a corresponding XML element; (3) when reading an XML file and constructing therefrom JAVA objects, the classes to be instantiated for each element should be identified. In this manner, different JAVA classes and/or different JAVA implementations may be supported using a single XML representation.

The JAVA to XML API accomplishes the above by defining an XmlReaderWriter interface. Any JAVA class to be converted to XML (or constructed from an XML document) must implement this interface. The XmlReaderWritre interface is defined as follows:

interface XmlReaderWriter {

FieldDescription[] getFieldDescriptions();
void setAttributes(Hashtable ht);
Hashtable getAttributes();

}

The first method getFieldDescriptions is required. This method allows a JAVA class to define how it should be converted. Typically, this will add just one line of code for all sub-elements contained by the class.

The second two methods are optional, and are not used if the class does not use attributes as mentioned above. The FieldDescription class will be described in more detail below. However, to illustrate it's use, the BookStore class of the above example implements the following structure:

class BookStore {

...
public FieldDescription[] getFieldDescriptions() {

return new FieldDescription[] {

new FieldDescriprion(“name”, String.class, “getName”,

“setName”),

new FieldDescription(“address”, Address.class,

“getAddress”, “setAddress”),

new FieldDescription(“books”, Vector.class, “getBooks”,

“setBooks”, Book.class, “book”),

}

}
public void setAttributes(Hashtable ht) {; } // not used
public void Hashtable getAttributes() { return null; } // not used

}

It should be noted that the BookStore class only needs to describe fields directly contained in it. That is, sub-elements such as Address and Book (contained in the collection) will provide their own implementation of the interface.

The FieldDescription Class

The FieldDescription class provides the set of information needed by the API to convert between JAVA and XML representations. In one embodiment, the FieldDescription uses one of the following field description class constructors:

(Form 1)

FieldDescription(String tagName, Class objectClass, String getMethod, String setMethod);

(Form 2)

FieldDescription(String tagName, Class objectClass, String getMethod, String setMethod, Object contentClasses);

(Form 3)

FieldDescription(String tagName, Class objectClass, String getMethod, String setMethod, Object contentClasses, Object ContentTagNames);

For simple elements, the above first form is used. When a field is represented as a Collection, Hashtable or an array, the above second or third forms are used.

The TagName parameter is used to identify an XML element tag for a corresponding JAVA field being converted to XML. The ObjectClass parameter is used to specify the JAVA class to be instantiated when constructing the field from an XML document or representation. The GetMethod parameter is used to identify the JAVA method invoked to retrieve this field. The SetMethod parameter is used to specify the JAVA method invoked to retrieve a described method.

TagName—when writing this field to XML, what name should be used for the corresponding XML element tag.

ObjectClass—Specifies the Class to instantiate when constructing this field from XML

GetMethod—The name of the JAVA method to invoke to retrieve this field.

SetMethod—The name of the JAVA method to invoke to retrieve this method.

The contentClass parameter is used to specify what class of object must be instantiated and constructed from the element. The instantiated object may comprise a single Class object, in which all elements are represented by the same class.

The instantiated class may be based on an element TagName where the parameter passed to the instantiated class is a Hashtable, where the keys are the element names, and where the values are the corresponding Class types. The instantiated class may also be based on an attribute value contained in the elements, in which case the parameter passed to the instantiated class is a Hashtable where they keys are specified in the form “attrName=attrValue”, and the values are the Class types to use.

A containing class specifies the element names to use for each field when writing the field to the XML document. The contentName parameter may be any of the following:

(1) The same name for all elements, in which case a single String containing the name of the element to use is passed. That is, the name is obtained by invoking a “get” method on the object, in which case a method name preceded by an “@” (e.g. “@getMyName”) should be specified. This method takes no parameters and should return a String.

(2) The name may be based on the class of object, in which case the HashTable keys are preferably the Class types and the corresponding values should be the TagName to use. Based on Hashtable keys, if collection is an instance of java.util.Hashtable, it is appropriate to use a FieldDescription constructor that does not take a contentName parameter.

In order to support inheritance, subclasses only need to define FieldDescriptions for new elements. The FieldDescriptions of the parent class are concatenated therefrom. For this purpose, one embodiment of the invention provides that the FieldDescription class has a concat method to make this easy. For example, using the book store data set, the ReviewedBook class inherits from the Book class, so it's getFieldDescription method could be written as:

class ReviewedBook extends Book {

...
public FieldDescription[] getFieldDescriptions() {

FieldDescription[] fda = new FieldDescription[] {

new FieldDescription(“reviews”, Vector.class,

“getReviews”, “setReviews”, Review.class, “reviews”)

};
return FieldDescription.concat( fda,
super.getFieldDescriptions() );

}

}

For example, in the case of the book collection, a Book object may be constructed for each element if only the base class is of interest. However, the construction of a different type, depending on the attribute, we may do that as well. We can modify the contentClass parameter to be a Hashtable, and specify the type based on attribute:

Hashtable ht=new Hashtable( );

ht.put(“reviewed=yes”, ReviewedBook.class);

ht.put(“reviewed=no”, Book.class);

fd=new FieldDescription(“books”, Vector.class, “getBooks”, “setBooks”, ht, “book”);

With the above attribute information, the API can determine what type of class to instantiate.

Attributes Versus Elements

The present invention may be implemented using either elements or attributes. That is, the particular object may comprise one or more “attributes.” For example, a User object may be of the following form:

User {

String id;
String lastName;
String firstName;
String phoneNumber

}

In this object model, id, lastName, firstName and phoneNumber are considered “attributes” of the object “User.” In an XML representation, this may be modeled as either of the following:

<user>

<id>1001</id>
<lastName>Smith</lastName>
<firstName>Joe</firstName>
<phoneNumber>732-222-1234</phoneNumber>

</user>

or as

<user id=”12345”>

<lastName>Smith</lastName>
<firstName>Joe</firstName>
<phoneNumber>732-222-1234</phoneNumber>

</user>

For the second modeling case, rather than describing the attribute “id” with a FieldDescription, it would be treated as an attribute in the User class:

Class user {

String id = null;
...
FieldDeseription[] getFieldDescriptions() {

return new FieldDescription[]

new FieldDescription(“lastName”, String.class,

“getLastName”, setLastName”),

new FieldDescription(“firstName”, Stringclass,

“getFirstName”, setFirstName”),

new FieldDescription(“phoneNumber”, String.class,

“getNumber”, “setNumber”),

};

}
Hashtable getAttributes() {

Hashtable ht = new Hashtable();
ht.put(“id”, id);
return ht;

void setAttriutes(Hashtable ht) {

String s = ht.get(“id”);
if( s !=null) this.id = new String(s);

}

The XmlUtil Class

This class provides static methods that load and save Documents to and from XML streams as well as converting Document objects to and from specified JAVA classes. For the above book store example, the complete code needed to save the BookStore to an XML file and later restore it is as follows:

//construct a book store and populate it with books . . .

BookStore bookStore=new BookStore( . . . );

Book book=new Book( . . . );

BookStore.add(book); //etc.

//turn it into a Document object and save to an XML file Document doc=XmlUtil.getDocument(“bookStore”, bookStore);

XmlUtil.writeXml(doc, “books.xml”);

//later, reload the book store from XML

Document doc=XmlUtil.readXml(“books.xml”);

BookStore bookStore=(BookStore)XmlUtil.getObject(doc, BookStore.class);

Collection books=bookStore.getBooks( ); //do something with books

The readXml and writeXml are used to read and write Documents to and from XML files (or more generally streams). The conversion from a JAVA object to XML is accomplished by:

Document XmlUtil.getDocument(String docName, Object obj);

As long as the top level object and contained objects implement XmlReaderWriter, the whole collection can be handled by this call. To convert a Document to any class implementing XmlReaderWriter, use:

Object XmlUtil.getObject(Document doc, Class objectClass);

An instance of objectClass will be instantiated and queried for its FieldDescriptions. From that point the API can determine how to convert all nodes that it encounters. This works recursively through the whole document tree. As mentioned, different object classes can be used to produce different results.

FIG. 2 depicts a flow diagram of a method for processing a JAVA class file. Specifically, FIG. 2 depicts a flow diagram of a method 200 for processing a JAVA class file to include annotations according to the present invention, and to provide interface functionality adapted to use such annotations.

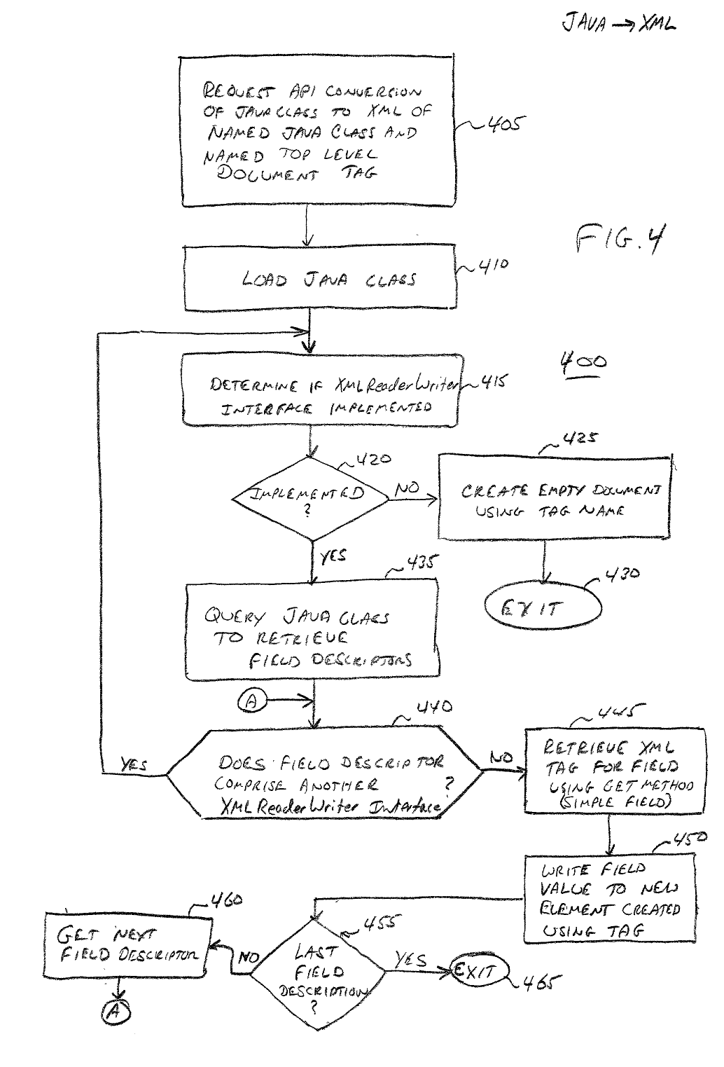

Important interface functionality adapted to use such annotations comprises, for example, the ability to convert between JAVA and XML. A method suitable for use by, for example, an application programming interface (API) for conversion between JAVA and XML will be described in more detail below with respect to FIG. 4. Briefly, this conversion may be implemented as follows:

1. A request is made to the API to convert a Java class to an XML representation. The name of the Java class and the name of the top level document tag are specified.

2. The Java class is loaded and checked to see if it implements the XmlReaderWriter interface. If it does not, an empty document is created with the tag name specified in step 1. and the procedure exits. If it does, proceed to step 3.

3. Query the Java class for its field descriptors. For each field descriptor, create the specified XML tag name. If the field is a simple type (String, Float, Integer, etc.) the value is retrieved using the specified get method and written to the newly created element. If the field represents another XmlReaderWriter, recursively enter step 2. for that element.

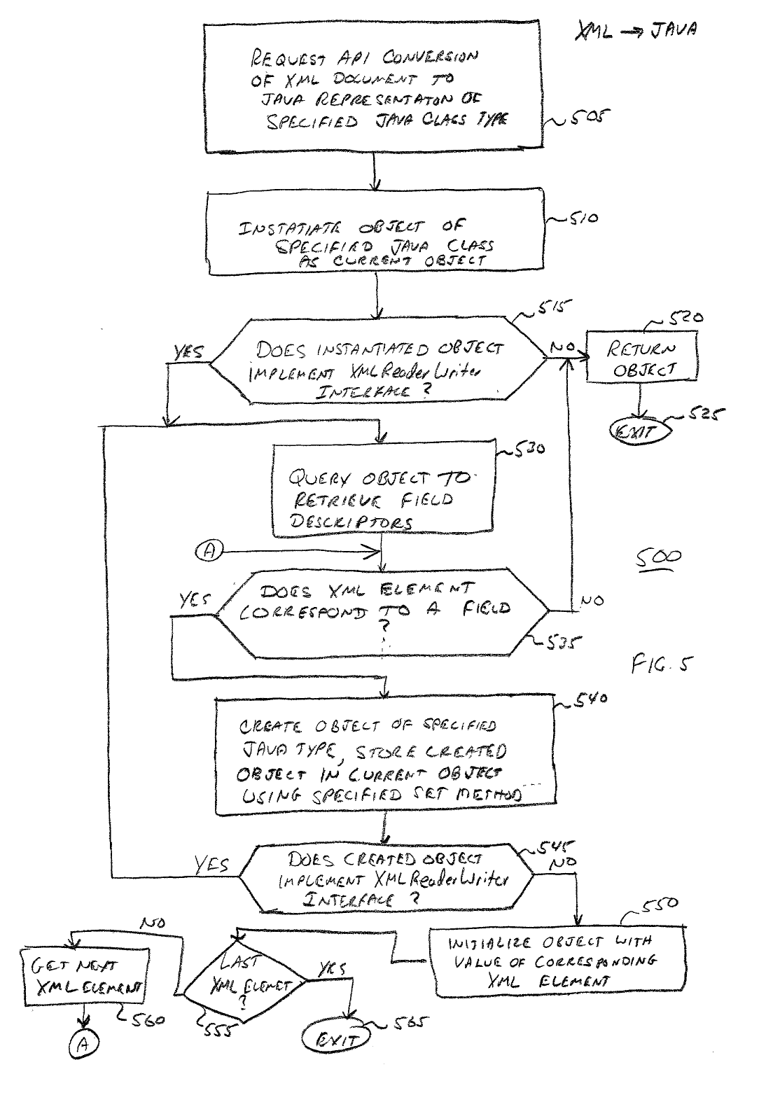

Similarly, a method suitable for use by an API for converting between XML and JAVA will be described below with respect to FIG. 5. Briefly, this method may be implemented as follows:

1. A request is made of the API to convert an XML document to a Java representation. The API is represented with the XML document and a Java class type.

2. An object of the specified Java class is instantiated.

3. If the object does not implement XmlReaderWriter, the object is returned. If it does, proceed to step 4.

4. The object is queried for it's field descriptions. For each field, the XML element is checked for a corresponding field. If found, an object of the specified Java type is created and stored in the current Java object using the specified set method. If the object implements XmlReaderWriter interface, step 2. is recursively entered. If it does not, it is initialized with the value of the corresponding XML element.

Referring now to FIG. 2, the method 200 is entered at step 205 when a file including JAVA class structures is received. At step 210, a first JAVA class is selected. At step 215 a decision is made as to whether the selected JAVA class includes information to be converted to an XML representation. If a selected JAVA class includes no information to be converted, then the method proceeds to step 245.

At step 245, a query is made as to whether the selected JAVA class comprises a last JAVA class within the received file. If the selected JAVA class is the last class within the received file, then at step 250 an XML ReaderWriter interface is defined in the manner previously discussed. Otherwise, at step 220 the structure of the selected JAVA class is annotated.

At step 225, a sub-element within the class to be annotated is selected. At step 230 a decision is made as to whether the sub-element includes information to be converted to an XML representation. If the query at step 230 is answered affirmatively, then the selected sub-element is annotated at step 240. At step 235, a query is made as to whether the selected sub-element, annotated or otherwise, comprises a last sub-element within the class to be annotated. If additional sub-elements exist, then the next sub-element is selected at step 225. Otherwise, the method proceeds to step 245.

FIG. 3 depicts a flow diagram of an annotation method according to the invention. Specifically, FIG. 3 depicts a flow diagram of a method 300 of annotating a JAVA class or class sub-element. The method 300 of FIG. 3 is suitable for use in implementing steps 220 and 240 of the method 200 of FIG. 2.

At step 310, a JAVA class structure or sub-element to be annotated is examined. At step 320, an appropriate field description class constructor is selected. As noted in box 330, the field description class constructors may comprise one of the form 1, form 2, and form 3 field description class constructors previously described. Alternatively, other field description class constructors may be applied.

At step 340, the selected form of field description class constructor is applied to the class or sub-element. That is, referring to box 350, for each field at least a TagName, ObjectClass, getMethod and setMethod parameter is specified. Optionally, a content class parameter or a ContentClass parameter in conjunction with a ContentTagName parameter is applied. The applied parameters are determined with respect to the selected field description class constructor. At step 360, the JAVA class file is annotated according to the constructor application performed at step 340.

The methods 200 and 300 of FIGS. 2 and 3 together provide for the iterative processing of the file including JAVA data structures such that appropriate annotations are inserted within the file. The inserted annotations are specifically designed to enable an API mechanism according to the invention to convert annotated JAVA data structures into corresponding XML representations. The resulting XML ReaderWriter interface is utilized by the API to convert between the JAVA and XML representations of a data set.

FIG. 4 depicts a flow diagram of a method for converting a JAVA class into an XML representation. The method 400 of FIG. 4 preferably utilizes a JAVA class that has been annotated in the manner described above with respect to FIGS. 1-3.

The method 400 of FIG. 4 is entered at step 405, where a request is made for API conversion of a JAVA class to an XML representation. The name of the JAVA class and the name of the top level XML document tag are specified.

At step 410, the named JAVA class is loaded, and at step 415 a determination is made as to whether the loaded JAVA class implements the XML ReaderWriter interface. At step 420, a query is made as to whether the determination at step 415 indicates that the XML ReaderWriter interface is implemented. If the query at step 420 is answered negatively, then the method 400 proceeds to step 425, where an empty XML document is created using the top level XML tag provided at step 405. The method 400 then exits at step 430.

If the query at step 420 is answered affirmatively, then at step 435 the JAVA class is queried to retrieve the field descriptors and included per the annotations provided in the interface. At step 440, a query is made as to whether a first field descriptor (or a next field descriptor) comprises another XML reader-writer interface. If the query at step 440 is answered affirmatively, then the method 400 proceeds to step 415. If the query at step 440 is answered negatively, then the method 400 proceeds to step 445.

At step 445, the XML tag for the field is retrieved using the appropriate get method, as described above with respect to FIG. 3. At step 450, the method 400 writes the field value to the new XML element created using the retrieved XML tag. At step 455, a query is made as to whether the field descriptor presently retrieved comprises the last field descriptor to be processed. If the query at step 455 is answered affirmatively, then the method 400 exits at step 465. If the query at step 455 is answered negatively, then the method 400 proceeds to step 460 where the next field descriptor is retrieved. The method 400 then proceeds to step 440.

The method 400 of FIG. 4 processes a JAVA class which has been previously annotated in support of the XML ReaderWriter interface such that a corresponding XML representation may be produced. It is noted that the XML representation so produced also implements the XML ReaderWriter interface such that conversion back to the JAVA class may be effected using, for example, the method 500 of FIG. 5.

FIG. 5 depicts a flow diagram of a method for converting an XML document to a JAVA class representation. The method 500 of FIG. 5 is preferably used to process an XML document that has been annotated in the manner described above with respect to FIGS. 1-4.

The method 500 of FIG. 5 is entered at step 505, where a request is made for API conversion of an XML document to a JAVA representation of a specified JAVA class type.

At step 510, an object of the specified JAVA class is instantiated as an object (i.e., a current object). At step 515, a query is made as to whether the instantiated object implements the XML ReaderWriter interface. If the query at step 515 is answered negatively, then the instantiated object is returned at step 520, and the method 500 exits at step 525. If the query at step 515 is answered affirmatively, then the method 500 proceeds to step 530.

At step 530, the instantiated object is queried to retrieve field descriptors. At step 535, a query is made as to whether a first (or next) XML element to be processed corresponds to one of the retrieved field descriptors. If the query at step 535 is answered negatively, then the method 500 proceeds to step 520, where the instantiated object is retrieved, and to step 525 where the method 500 is exited. If the query at step 535 is answered affirmatively, then the method 500 proceeds to step 540.

At step 540, an object of the specified JAVA type is created, and the created object is stored within the currently processed object using the specified set method, as described in more detail above with respect to FIG. 3. At step 545, a query is made as to whether the created object implements the XML ReaderWriter interface. If the query at step 545 is answered affirmatively, then the method 500 proceeds to step 530, where field descriptors are retrieved. If the query at step 545 is answered negatively, then the method 500 proceeds to step 550, where the created object is initialized with the value of the corresponding XML element.

At step 555, a query is made as to whether the XML element processed at step 550 is the last XML element to be processed. If the query at step 555 is answered affirmatively, then the method 500 exits at step 565. If the query at step 555 is answered negatively, then the method 500 proceeds to step 560, where the next XML element to be processed is retrieved, and then to step 535.

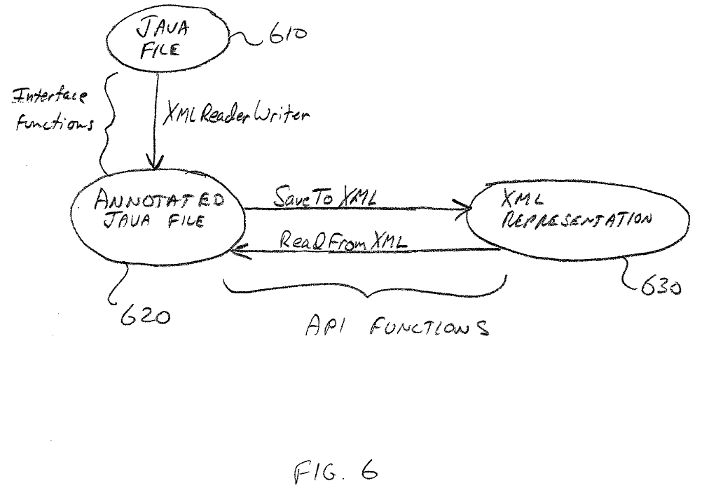

FIG. 6 depicts a high level graphical representation of processing useful in understanding the present invention. Specifically, FIG. 6 depicts a JAVA file 610 which is processed according to the XML ReaderWriter interface (i.e., the interface function) to produce an annotated JAVA file 620. The API function SaveToXml is used to convert the annotated JAVA file 620 into a corresponding XML representation 630. The API function ReadFromXml is used to convert the XML representation 630 (or any XML document including XML ReaderWriter interface annotations) into an annotated JAVA file, such as annotated JAVA file 620. The SaveToXml API function is described above with respect to FIG. 4, while the ReadFromXml API function is described above with respect to FIG. 5. Each of these functions may be further modified according to the various embodiments described above with respect to the FIGS.

Although various embodiments which incorporate the teachings of the present invention have been shown and described in detail herein, those skilled in the art can readily devise many other varied embodiments that still incorporate these teachings.

1. A method for processing a JAVA class to produce an XML document, comprising:
loading the named JAVA class;
determining if the loaded JAVA class implements a predefined interface, said predefined interface comprising annotations including a first parameter, for associating said JAVA class field with a corresponding XML element tag, a second parameter, for specifying a JAVA class to be instantiated when constructing said JAVA class field from said XML file, a third parameter, for identifying a JAVA method to invoke for retrieving said JAVA class field, and a fourth parameter, for identifying a JAVA method to invoke for retrieving this method; and
in the case of said loaded JAVA class implementing said predefined interface iteratively processing each field descriptor within the loaded JAVA class to retrieve corresponding XML tag; and
transferring field values to new elements created using said corresponding XML tags.

2. A method for processing an XML document to produce a JAVA class, comprising:
instantiating an object of the desired JAVA class;
in the case of said instantiated object, implementing a predefined interface, iteratively processing each object included within said instantiated object according to the steps of:
retrieving field descriptors associated with an object being processed;
creating an object of specified JAVA type for each XML element corresponding to a field descriptor; and
storing the created object in the currently processed object.

3. A method for adapting a JAVA object to an application programming interface (API) for converting said JAVA object to extensible Markup Language (XML), comprising:
annotating said JAVA object to include, for each JAVA object to be converted to XML, identification of a respective XML tag, identification of a JAVA class to be instantiated when constructing said JAVA object field from an XML file, identification of a JAVA method to invoke for retrieving said JAVA object and identification of a JAVA method to invoke for retrieving said retrieval method.

4. An application programming interface (API) for converting at least from JAVA to extensible mark-up language (XML), comprising:
a field description retrieval method, for determining JAVA conversion parameters by examining an annotation associated with each JAVA element to be converted to XML, said annotation defining for each JAVA element at least a corresponding XML tag, a corresponding object class, a corresponding field retrieval method, and a corresponding method retrieval method.

5. The API of claim 4, further comprising:
a JAVA to XML conversion method implemented according to the steps of:
loading the named JAVA class;
determining if the loaded JAVA class implements a predefined interface, said predefined interface comprising annotations including a first parameter, for associating said JAVA class field with a corresponding XML element tag, a second parameter, for specifying a JAVA class to be instantiated when constructing said JAVA class field from said XML file, a third parameter, for identifying a JAVA method to invoke for retrieving said JAVA class field, and a fourth parameter, for identifying a JAVA method to invoke for retrieving this method; and
in the case of said loaded JAVA class implementing said predefined interface iteratively processing each field descriptor within the loaded JAVA class to retrieve corresponding XML tag; and
transferring field values to new elements created using said corresponding XML tags.

6. The API of claim 4, further comprising:
an XML to JAVA conversion method, comprising:
instantiating an object of the desired JAVA class;
in the case of said instantiated object implementing a predefined interface, iteratively processing each object included within said instantiated object according to the steps of:
retrieving field descriptors associated with an object being processed;
creating an object of specified JAVA type for each XML element corresponding to a field descriptor; and
storing the created object in the currently processed object.

7. A data structure for describing a JAVA class field in a manner facilitating XML conversion, comprising:
a first parameter, for associating said JAVA class field with a corresponding XML element tag;
a second parameter, for specifying a JAVA class to be instantiated when constructing said JAVA class field from said XML file;
a third parameter, for identifying a JAVA method to invoke for retrieving said JAVA class field; and
a fourth parameter, for identifying a JAVA method to invoke for retrieving this method.

8. The data structure of claim 7, further comprising:
a fifth parameter, for specifying a type of JAVA object to instantiate for an XML element representing a collection.

9. The data structure of claim 8, further comprising:
a sixth parameter, for specifying a tag name to use for each element representing a collection.

10. The data structure of claim 8, wherein said collection comprises a HashTable.
